(19) United States
(12) Patent Application Publication
(10) Pub. No.: US 2009/0216942 A1
(43) Pub. Date: Aug. 27, 2009

(54) EFFICIENT MEMORY MANAGEMENT FOR HARD DISK DRIVE (HDD) READ CHANNEL

(75) Inventor: Johnson Yen, Fremont, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/061,804

(22) Filed: Apr. 3, 2008

Related U.S. Application Data
(60) Provisional application No. 61/030,960, filed on Feb. 23, 2008.

(51) Int. Cl. G06F 12/00; G06F 13/00

(52) U.S. Cl. 711/112; 710/52; 711/E12.001

(57) ABSTRACT

Efficient memory management for hard disk drive (HDD) read channel. The memory management presented herein can be broadly applied to any interface in which data is provided from a first location to a second location. A number of buffer units are employed, arranged into a number of slices, in which data is selectively written so that the information can be provided to the memory management architecture at a first rate, stored in the memory management architecture, and then output from the memory management architecture at a second rate. This ensures appropriate interfacing of information while also performing appropriate rate adjustment. The data is partitioned into a number of portions, and each portion also includes multiple subsets. On a subset basis, information of a first portion is provided to a first slice's buffer units, and information of a second portion is provided to a second slice's buffer units.

### CROSS REFERENCE TO RELATED PATENTS/PATENT APPLICATIONS

### Provisional Priority Claims

The present U.S. Utility patent Application claims priority pursuant to 35 U.S.C. § 119(e) to the following U.S. Provisional Patent Application which is hereby incorporated herein by reference in its entirety and made part of the present U.S. Utility patent Application for all purposes:

1. U.S. Provisional Application Ser. No. 61/030,960, entitled “Efficient memory management for hard disk drive (HDD) read channel,” (Attorney Docket No. BP6966), filed 02-23-2008, pending.

### BACKGROUND OF THE INVENTION

1. Technical Field of the Invention

The invention relates generally to information management; and, more particularly, it relates to memory management employed to effectuate information management within various devices including communication device and/or other devices that may include a hard disk drive (HDD).

2. Description of Related Art

Data communication systems have been under continual development for many years. One such type of communication system that has been of significant interest lately is a communication system that employs iterative error correction codes. Communications systems with iterative codes are often able to achieve lower bit error rates (BER) than alternative codes for a given signal to noise ratio (SNR).

A continual and primary directive in this area of development has been to try continually to lower the SNR required to achieve a given BER within a communication system. The ideal goal has been to try to reach Shannon's limit in a communication channel. Shannon's limit may be viewed as being the data rate to be used in a communication channel, having a particular SNR, that achieves error free transmission through the communication channel. In other words, the Shannon limit is the theoretical bound for channel capacity for a given modulation and code rate.

As is known, many varieties of memory storage devices (e.g. hard disk drives (HDDs)), such as magnetic disk drives are used to provide data storage for a host device, either directly, or through a network such as a storage area network (SAN) or network attached storage (NAS). Such a memory storage system (e.g., a HDD) can itself be viewed as a communication system in which information is encoded and provided via a communication channel to a storage media; the reverse direction of communication is also performed in a HDD in which data is read from the media and passed through the communication channel (e.g., sometimes referred to as a read channel in the HDD context) at which point it is decoded to makes estimates of the information that is read.

Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

Within such information storage applications, sometimes the information is provided at a first rate from a first location and needs to be provided to a second location at a second rate. While the prior art has provided some solutions to try to address this situation, these prior art approaches are generally very memory consumptive, have increased form factor, and thereby increase the overall cost of such an apparatus that includes such prior art architectures.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 illustrates an embodiment of a disk drive unit.

FIG. 2 illustrates an embodiment of an apparatus that includes a disk controller.

FIG. 3A illustrates an embodiment of a handheld audio unit.

FIG. 3B illustrates an embodiment of a computer.

FIG. 3C illustrates an embodiment of a wireless communication device.

FIG. 3D illustrates an embodiment of a personal digital assistant (PDA).

FIG. 3E illustrates an embodiment of a laptop computer.

FIG. 4 illustrates an embodiment of a communication system.

FIG. 5 illustrates an embodiment of an apparatus implemented to perform memory management.

FIG. 6 illustrates an embodiment of an ingress memory management unit (MMU).

FIG. 7 illustrates an embodiment of an egress MMU.

FIG. 8 illustrates an embodiment of an apparatus implemented to perform memory management using two slices.

FIG. 9 illustrates an embodiment of an apparatus implemented to perform memory management using three slices.

FIG. 10 illustrates an embodiment of an apparatus implemented to perform memory management using four slices.

FIG. 11 illustrates an embodiment of a comparison of memory size and area savings provided by various implementations of an apparatus implemented to perform memory management.

FIG. 12 illustrates an embodiment of a method for performing memory management.

### DETAILED DESCRIPTION OF THE INVENTION

A novel means is presented herein in which memory management is implemented/performed in an efficient manner that provides significant resource savings when compared to prior art approaches. In some embodiments, the memory management architecture can be further partitioned into an ingress memory management unit (MMU) and an egress MMU.

The memory management architecture also is implemented to accommodate into and output of information at different rates. For example, the memory management architecture presented herein can receive information at a first rate and output that information at a second rate. As one particular example, the memory management architecture presented herein can receive information at rate that is twice the rate at which the information is output. Clearly, other variations and ratios of input rate to output rate may also be implemented using the means presented herein (e.g., input rate being one-half of output rate, input rate being three times the output rate, or other relationships, etc.).

Multiple buffered units, which may be viewed as being arranged into slices, are employed to perform appropriate input receiving and buffering of information and outputting of that information as well. The data may be viewed as being partitioned into various portions, and each portion can be viewed as including more than one subset. The subsets of a given portion of data are appropriately stored into the buffer units corresponding to a slice. By using multiple slices, first data can written to and stored within buffer units of a first slice, and second data can written to and stored within buffer units of a second slice.

In the HDD context, this memory management architecture provides an efficient scheme to reduce silicon area for a memory buffer in the sector slice channel architecture. The area employed using this memory management architecture is smaller than a first-in-first-out (FIFO buffer) implementation or a circular buffer implementation. Also in the HDD context, for the interface between an analog front end (AFE) and the sector slices, one sector of data (4 kilo-byte samples) needs approximately 250 kilo-bits of SRAM space (e.g., approximately 0.2 mm̂2). Generally speaking, the buffer memory is big in the sector slice channel architecture. For example, the memory buffer area employed is about 0.8 mm̂2 by using the traditional FIFO or circular buffer approaches mentioned above. The novel memory management architecture employed herein can reduce the size of the buffer memory by as much as a half. For example, when compared to the traditional FIFO or circular buffer approaches mentioned above, the novel memory management architecture employed herein can save approximately 0.4 mm̂2 of silicon area.

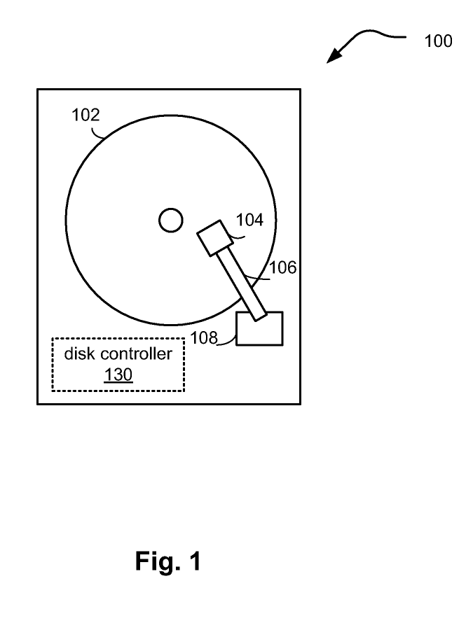

FIG. 1 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM; however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write heads 104 that are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device.

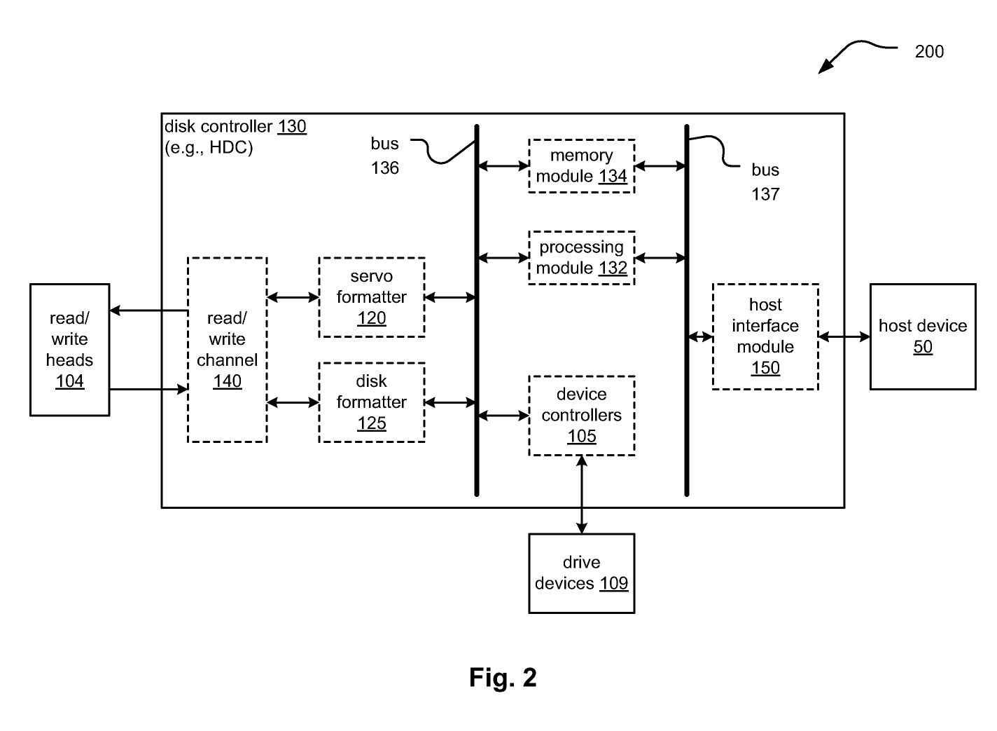

FIG. 2 illustrates an embodiment of an apparatus 200 that includes a disk controller 130. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102. Servo formatter 120 provides clock signals and other timing signals based on servo control data read from disk 102. Device controllers 105 control the operation of drive devices 109 such as actuator 108 and the servo motor, etc. Host interface 150 receives read and write commands from host device 50 and transmits data read from disk 102 along with other control information in accordance with a host interface protocol. In one embodiment, the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing module 132, memory module 134, read/write channel 140, disk formatter 125, and servo formatter 120 that are interconnected via bus 136 and bus 137. The host interface 150 can be connected to only the bus 137 and communicates with the host device 50. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in various embodiments.

In one possible embodiment, one or more modules of disk controller 130 are implemented as part of a system on a chip (SoC) integrated circuit. In an embodiment, this SoC integrated circuit includes a digital portion that can include additional modules such as protocol converters, linear block code encoding and decoding modules, etc., and an analog portion that includes device controllers 105 and optionally additional modules, such as a power supply, etc. In a further embodiment, the various functions and features of disk controller 130 are implemented in a plurality of integrated circuit devices that communicate and combine to perform the functionality of disk controller 130.

When the drive unit 100 is manufactured, disk formatter 125 writes a plurality of servo wedges along with a corresponding plurality of servo address marks at equal radial distance along the disk 102. The servo address marks are used by the timing generator for triggering the “start time” for various events employed when accessing the media of the disk 102 through read/write heads 104.

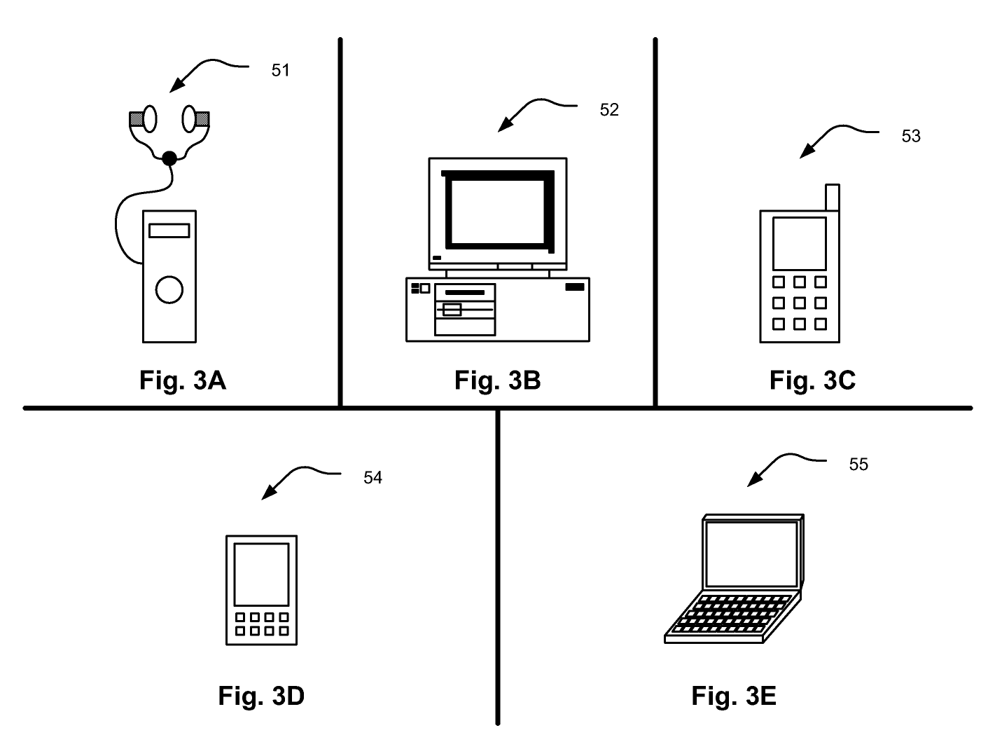

FIG. 3A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 3B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 3C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 3D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG joint photographic expert group) files, bitmap files and files stored in other graphics formats, emails, webpage information and other information downloaded from the Internet, address book information, and/or any other type of information that may be stored in a digital format.

FIG. 3E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

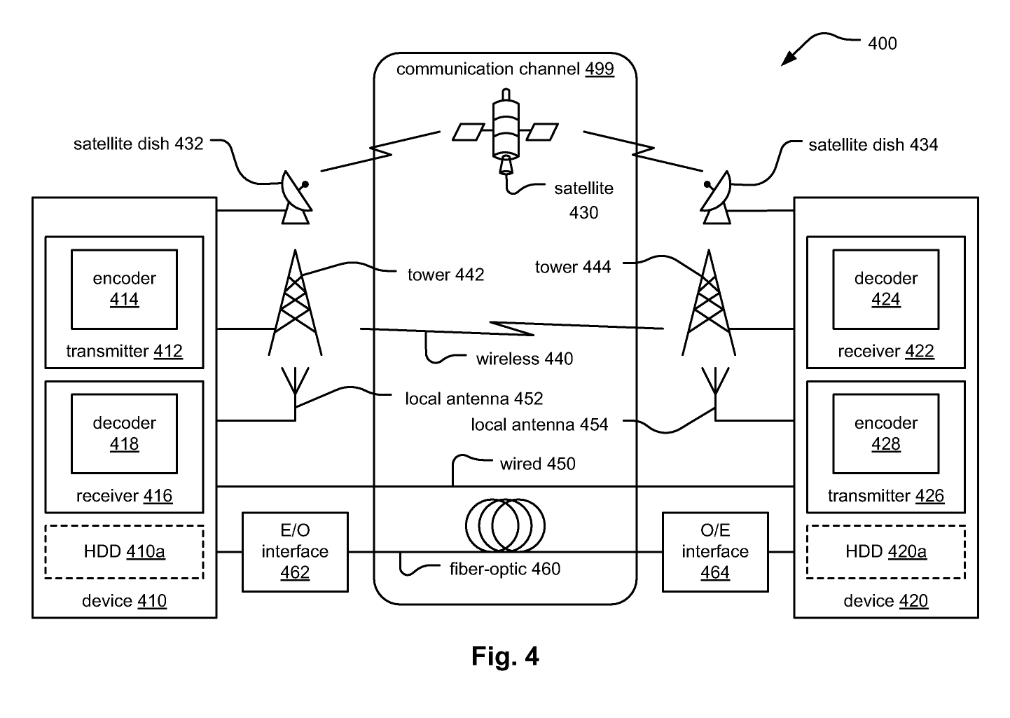

FIG. 4 is a diagram illustrating an embodiment of a communication system 400.

Referring to FIG. 4, this embodiment of a communication system 400 is a communication channel 499 that communicatively couples a communication device 410 (including a transmitter 412 having an encoder 414 and including a receiver 416 having a decoder 418) situated at one end of the communication channel 499 to another communication device 420 (including a transmitter 426 having an encoder 428 and including a receiver 422 having a decoder 424) at the other end of the communication channel 499. In some embodiments, either of the communication devices 410 and 420 may only include a transmitter or a receiver. There are several different types of media by which the communication channel 499 may be implemented (e.g., a satellite communication channel 430 using satellite dishes 432 and 434, a wireless communication channel 440 using towers 442 and 444 and/or local antennae 452 and 454, a wired communication channel 450, and/or a fiber-optic communication channel 460 using electrical to optical (E/O) interface 462 and optical to electrical (O/E) interface 464)). In addition, more than one type of media may be implemented and interfaced together thereby forming the communication channel 499.

Either one of both of the communication device 410 and the communication device 420 can include a hard disk drive (HDD) (or be coupled to a HDD). For example, the communication device 410 can include a HDD 410a, and the communication device 420 can include a HDD 420a.

The signals employed within this embodiment of a communication system 400 can be Reed-Solomon (RS) coded signals, LDPC (Low Density Parity Check) coded signal, turbo coded signals, turbo trellis coded modulation (TTCM), or coded signal generated using some other error correction code (ECC).

In addition, these signals can undergo processing to generate a cyclic redundancy check (CRC) and append it (or attach it) to data between transferred between the communication device 410 and the communication device 420 9 or vice versa) or to data being transferred to and from the HDD 410a within the communication device 410 or to and from the HDD 420a within the communication device 420.

Any of a very wide variety of applications that perform transferring of data from one location to another (e.g., including from a first location to a HDD, or from the HDD to another location) can benefit from various aspects of the invention, including any of those types of communication devices and/or communication systems depicted in FIG. 4. Moreover, other types of devices and applications that employ CRCs (e.g., including those employing some type of HDD or other memory storage means) can also benefit from various aspects of the invention.

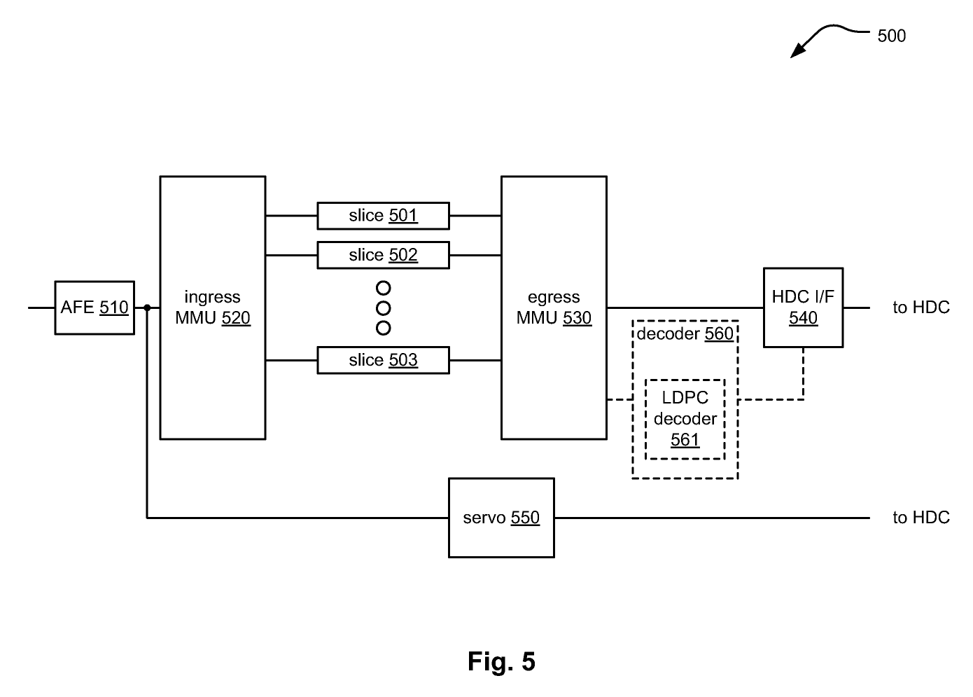

FIG. 5 illustrates an embodiment of an apparatus 500 implemented to perform memory management. An analog front end (AFE) 510 receives an analog signal from storage media of a memory storage device (e.g., an HDD). The AFE 510 can be implemented to perform a variety of functions including scaling, gain adjustment, filtering, digital sampling, etc. An ingress memory management unit (MMU) 520 receives the now-digital version of the incoming data, and this information is also provided to a servo 550 whose output is provided to a hard disk controller (HDC). The data output from the ingress MMU 520 is provided via a number of slices (e.g., shown as slice 501, slice 502, and so on until slice 503) to an egress MMU 530. In one embodiment, the output of the egress MMU 530 can be provided directly to an HDC interface 540 whose output is provided to the HDC. Alternatively, in another embodiment, the output from the egress MMU 530 can be provided to a decoder 560 in those instances when the information read from the storage media has undergone some form of error correction encoding. In some embodiments, the decoder 560 can be an LDPC (Low Density Parity Check) decoder 561; alternatively, another type of decoder can be employed to correspond to the manner in which the data has been encoded before being written to the storage media.

The apparatus 500 can be implemented to employ a scatter and gather mechanism to manage the memory buffer unit allocation within each of the various slices 501-503.

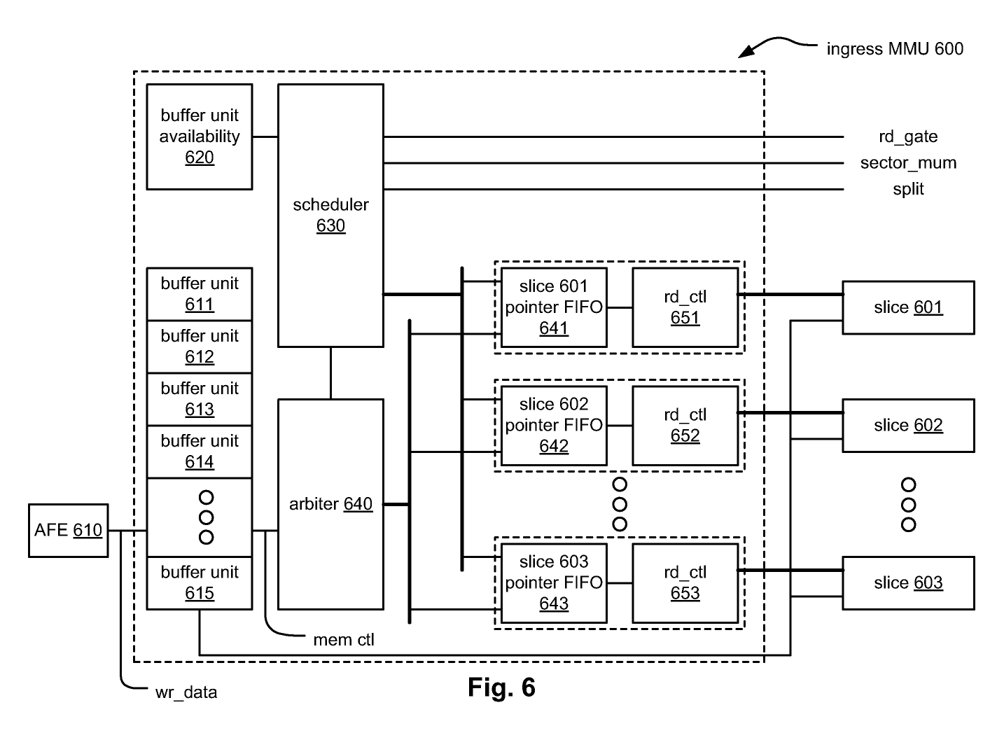

FIG. 6 illustrates an embodiment of an ingress memory management unit (MMU) 600. This ingress MMU 600 may be viewed as being one possible implantation of the egress MMU 530 of the embodiment of FIG. 5.

The ingress MMU 600 includes a data buffer memory that includes a number of buffer units (e.g., shown as buffer unit 611, buffer unit 612, buffer unit 613, buffer unit 614, and so on until buffer unit 615). A buffer unit availability module 620 operates to keep an updated record of which of the buffer units are free. A scheduler 630 and an arbiter 640 also operate cooperatively to provide portions of the data to selected buffer units based on the status as provided by the buffer unit availability module 620.

A number of slice pointer FIFO and read control (shown as rd_ctl) modules operate to provide the data via the various slices (e.g., slice 601-603) which then couple to an egress MMU. For example, a slice 601 pointer FIFO 641 operates cooperatively with read control module 651 to provide information appropriately from the buffer units to the slice 601. A slice 602 pointer FIFO 642 operates cooperatively with read control module 652 to provide information appropriately from the buffer units to the slice 602. A slice 603 pointer FIFO 643 operates cooperatively with read control module 653 to provide information appropriately from the buffer units to the slice 603.

The buffer units 611-615 are the main memory body implemented to store the digitally sampled information provided from the AFE 610. In one embodiment, a single port static random access memory (SRAM) module is employed for the buffer units 611-615; however, other forms of memory can alternatively be employed as well without departing from the scope and spirit of the invention.

The buffer unit availability module 620 is implemented to monitor which of the buffer units 611-615 are free and available to receive and store incoming data. The buffer unit availability module 620 monitors which of the buffer units 611-615 are not occupied yet. The scheduler 630 is implemented to schedule the incoming sector data to the destination slices. In an HDD context in which the data is partitioned into sectors, the incoming sectors are forwarded to those slices sequentially in a round-robin fashion and all split segments belong to one sector, and they are then forwarded to the same slice. In some embodiments, the slices can be masked out, so no sectors will be forwarded to them. The arbiter 640 is implemented to handle arbitration of memory accesses among each of the slices and the AFE 610.

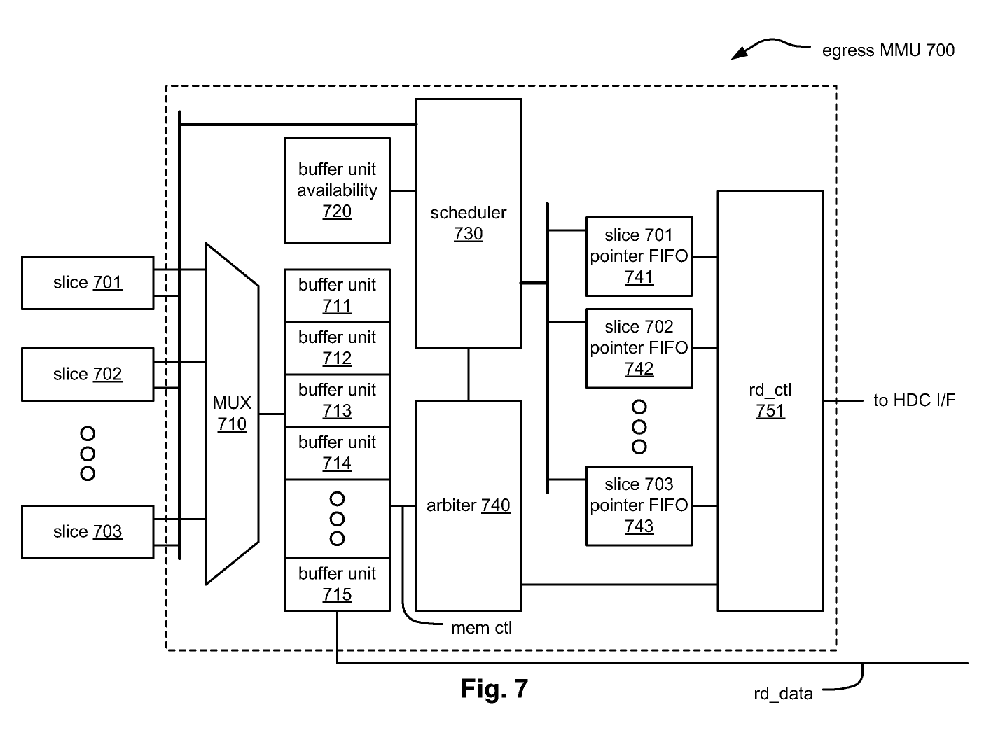

FIG. 7 illustrates an embodiment of an egress MMU 700. This egress MMU 700 may be viewed as being one possible implantation of the ingress MMU 520 of the previous embodiment. This egress MMU 700 can be viewed as being complementary to the ingress MMU 600 of the previous embodiment with at least one difference being that the egress MMU 700 takes information from a number of slices (e.g., shown as slice 701, slice 702, and so on until slice 703). There are some similarities between the egress MMU 700 and the ingress MMU 600, in that, the egress MMU 700 includes a corresponding number of buffer units (e.g., the FIG. 7 includes buffer units 711-715), a buffer unit availability module 720, a scheduler 730, and an arbiter 740. However, the egress MMU 700 includes a number of slice pointer FIFO buffers 741-743 that coupled directly to a single read control module 751 that couples to the HDC interface. Also, for appropriate allocation of incoming data from the slices 701-703, a multiplexer (MUX) 710 ensures providing to the appropriate buffer units within the buffer units 711-715.

Several of the following embodiments depict how any desired number of slices may be implemented to perform memory management in accordance with the various aspects presented herein. The reader is referred to other of the embodiments presented herein to see how a number of slices (e.g., in FIG. 5, FIG. 6, and/or FIG. 7) are employed in accordance with various memory management architectures.

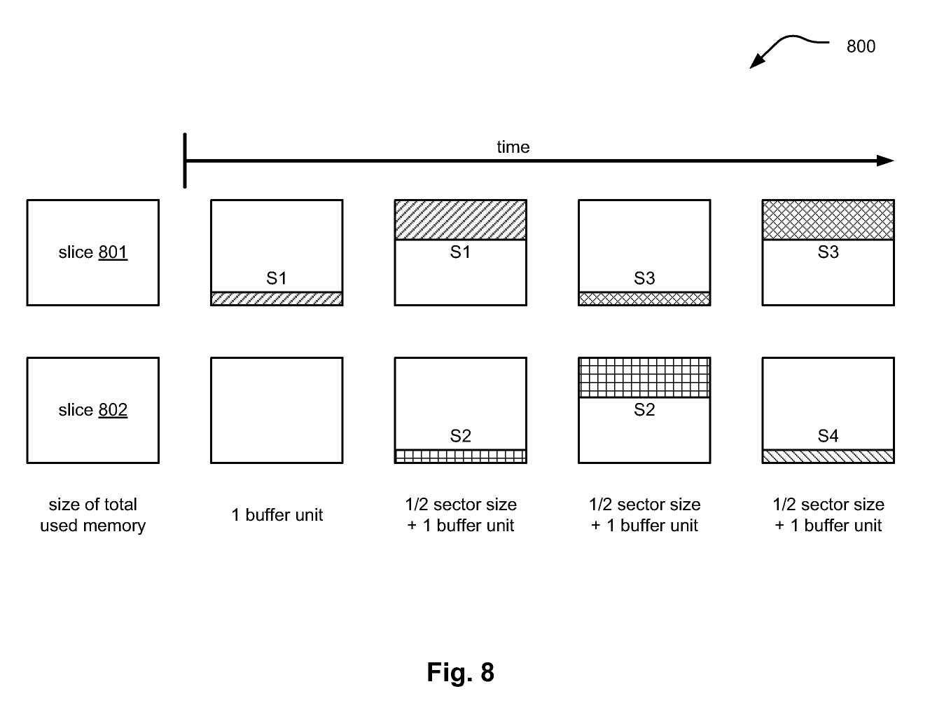

FIG. 8 illustrates an embodiment of an apparatus 800 implemented to perform memory management using two slices. This embodiment includes two slices (e.g., a slice 801 and a slice 802). As a function of time, it can be seen how each of the slices fill up with and sends out its data. It is noted that immediately as the data is received within a first buffer unit within a slice, it begins to be sent out. Because the data coming in may be at a different rate that the rate at which the data is sent out, the data continues to fill up additional buffer units within a given slice.

Each of the slices can be viewed as including multiple buffer units. The data that is input may be viewed as being partitioned into a number of portions, and each portion thereof includes a number of subsets. In an HDD context, each portion may be viewed as being a sector of data that is retrieved from storage media of the HDD or a sector to be written to the storage media of the HDD. Each subset of the portion of data (e.g., each subset of a sector) is an amount of data or information that a buffer unit can hold.

Looking at FIG. 8, a first portion of the data (S1) is provided to a first buffer unit that is located near the bottom of slice 801. At this point, the amount of memory required is 1 buffer unit. Immediately as the incoming data is provided to buffer units within the slice 801, it begins to be output there from. However, when the data is incoming at a rate that is faster that a rate at which it is output, then additional buffer units continue to be filled up with data while the data is being output. This can be viewed as the buffer units being filled up a bit faster than they are being emptied in this particular slice. Based on a difference of rates in which data is input and output, there will be a steady-state operating point at which data a sufficient amount of memory, based on a number of slices employed, may be determined.

For example, a second portion of the data (e.g., additional parts of the data of S1) is provided from the input to a second buffer unit (which may also be located within the slice 801) while an output outputs a first subset of the first portion of the data (S1) from the first buffer unit within slice 801. In other words, the data of S1 continues to be provided to other buffer units within slice 801 while the initial subsets of the data of S1, which were initially written to the first buffer unit of slice 801, actually get output from the slice 801.

A third portion of the data (e.g., yet another part of the data of S1) is provided from the input to a third buffer unit located also in slice 801 while the output outputs a second subset (e.g., enough to fill a buffer unit) of the first portion of the data of S1 from the first buffer unit. Again, the data of continues to be provided to other buffer units within slice 801 while the initial and subsequent subsets of the data of S1, which were initially written to the first buffer unit and the second buffer unit of slice 801, actually get output from the slice 801.

After a sufficient period of time has passed so that the initial data originally put into the first buffer unit has been output thereby freeing up the first buffer unit, then a fourth portion of the data (S1) can be provided from the input to the first buffer unit (which is now free) while the output outputs a first subset of the second portion of the data from the second buffer unit. For example, the data is selectively input to those buffer units which are free while the data is output.

The allocation and order of which buffer units are to be employed (e.g., filled up with data and then that data output) need not be a sequential with respect to the order in which the buffer units are provisioned. For example, depending on buffer unit availability, a just freed up buffer unit may be employed for a very next portion of data that is incoming.

As can be seen, the data of S1 is written to buffer units within slice 801 and output from those buffer units within slice 801. Then, as data of S2 is incoming, it is written to buffer units within slice 802 while the remaining portions of the data of S1 are output from the buffer units in slice 801.

This process continues, in that, as data of S3 is incoming, it is written to buffer units within slice 801 while the remaining portions of the data of S2 are output from the buffer units in slice 802. As data of S4 is incoming, it is written to buffer units within slice 802 while the remaining portions of the data of S3 are output from the buffer units in slice 801. Eventually, the remaining portions of the data of S4 are output from the buffer units in slice 802.

As can be seen, there is a steady-state maximum amount of memory that is required which is memory corresponding to ½ of the memory of one of the portions of data (e.g., ½ of data portion S1, S2, S3, or S4) plus the memory of one buffer unit. In the HDD context, this can be viewed as needing enough memory for ½ of the data within a sector plus the memory of one buffer unit.

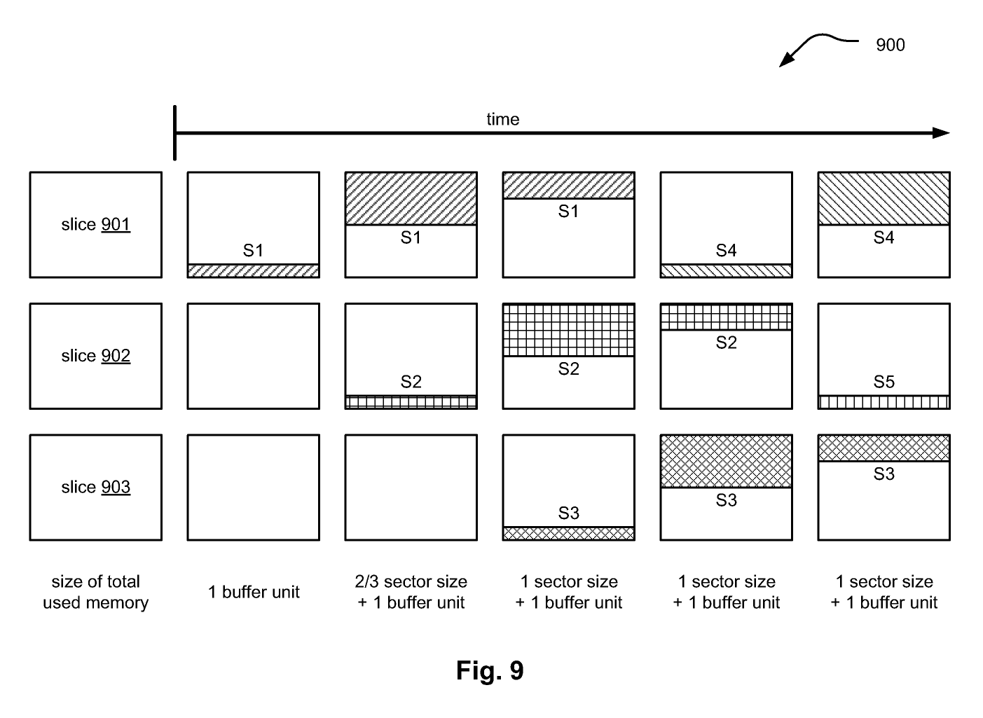

FIG. 9 illustrates an embodiment of an apparatus 900 implemented to perform memory management using three slices. This embodiment includes three slices (e.g., a slice 901, a slice 902, and a slice 903). Again, as a function of time, it can be seen how each of the slices fill up with and sends out its data. It is noted that immediately as the data is received within a first buffer unit within a slice, it begins to be sent out. Because the data coming in may be at a different rate that the rate at which the data is sent out, the data continues to fill up additional buffer units within a given slice.

As can be seen, the data of S1 is written to buffer units within slice 901 and output from those buffer units within slice 901. Then, as data of S2 is incoming, it is written to buffer units within slice 902 while the remaining portions of the data of S1 are output from the buffer units in slice 901.

This process continues, in that, as data of S3 is incoming, it is written to buffer units within slice 903 while the remaining portions of the data of S1 are output from the buffer units in slice 901 followed by the remaining portions of the data of S2 which are output from the buffer units in slice 902.

As data of S4 is incoming, it is written to buffer units within slice 901 (which have now been freed up after the data from S1 has been output there from) while the remaining portions of the data of S2 are output from the buffer units in slice 902 and the followed by the remaining portions of the data of S3 which are output from the buffer units in slice 903.

As data of S5 is incoming, it is written to buffer units within slice 902 (which have now been freed up after the data from S2 has been output there from) while the remaining portions of the data of S3 are output from the buffer units in slice 903 and the followed by the remaining portions of the data of S4 which are output from the buffer units in slice 901.

Eventually, the remaining portions of the data of S5 are output from the buffer units in slice 902.

As can be seen, there is a steady-state maximum amount of memory that is required which is memory corresponding to the memory of one of the portions of data (e.g., data portion S1, S2, S3, or S4) plus the memory of one buffer unit. In the HDD context, this can be viewed as needing enough memory for the data within a sector plus the memory of one buffer unit.

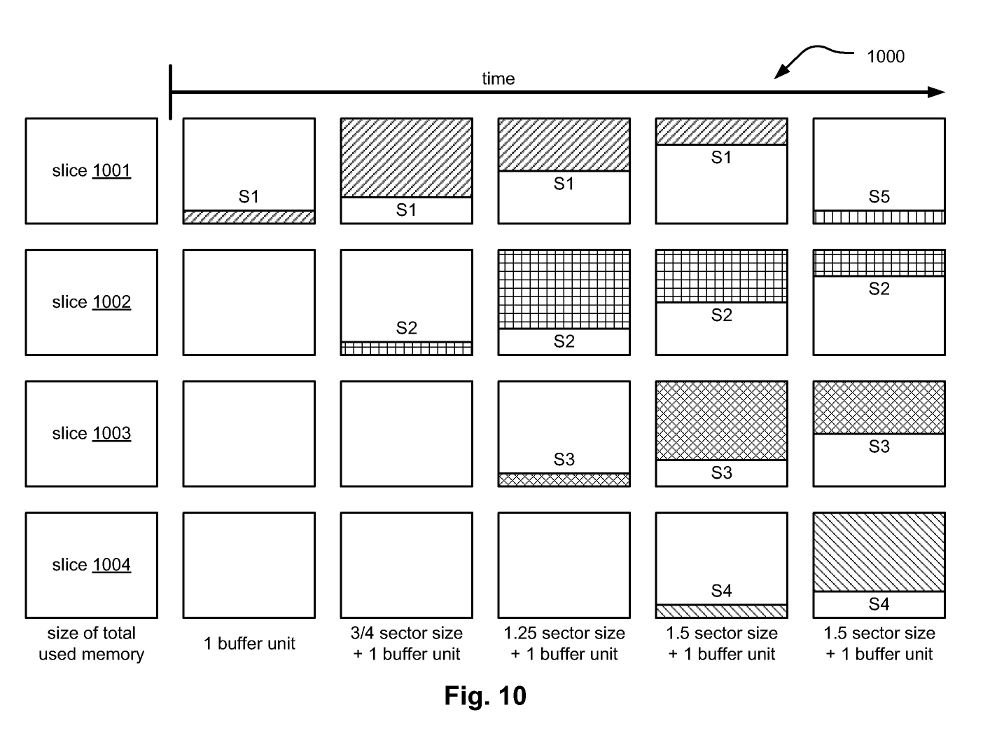

FIG. 10 illustrates an embodiment of an apparatus 1000 implemented to perform memory management using four slices. This embodiment includes four slices (e.g., a slice 1001, a slice 1002, a slice 1003, and a slice 1004). Again, as a function of time, it can be seen how each of the slices fill up with and sends out its data. It is noted that immediately as the data is received within a first buffer unit within a slice, it begins to be sent out. Because the data coming in may be at a different rate that the rate at which the data is sent out, the data continues to fill up additional buffer units within a given slice.

As can be seen, the data of S1 is written to buffer units within slice 1001 and output from those buffer units within slice 1001. Then, as data of S2 is incoming, it is written to buffer units within slice 1002 while the remaining portions of the data of S1 are output from the buffer units in slice 1001.

This process continues, in that, as data of S3 is incoming, it is written to buffer units within slice 1003 while the remaining portions of the data of S1 are output from the buffer units in slice 1001 followed by the remaining portions of the data of S2 which are output from the buffer units in slice 1002.

This process continues, in that, as data of S4 is incoming, it is written to buffer units within slice 1004 while the remaining portions of the data of S1 are output from the buffer units in slice 1001 followed by the remaining portions of the data of S2 which are output from the buffer units in slice 1002 followed by the remaining portions of the data of S3 which are output from the buffer units in slice 1003.

Once there are freed up buffer units within slice 1001 are available (e.g., data of S1 has been output there from), this process continues, in that, as data of S5 is incoming, it is written to those now-available buffer units within slice 1001 while the remaining portions of the data of S2 are output from the buffer units in slice 1002 followed by the remaining portions of the data of S3 which are output from the buffer units in slice 1003 followed by the remaining portions of the data of S4 which are output from the buffer units in slice 1004.

As can be seen, there is a steady-state maximum amount of memory that is required which is memory corresponding to 1½ of the memory of one of the portions of data (e.g., 1½ of data portion S1, S2, S3, or S4) plus the memory of one buffer unit. In the HDD context, this can be viewed as needing enough memory for 1½ of the data within a sector plus the memory of one buffer unit.

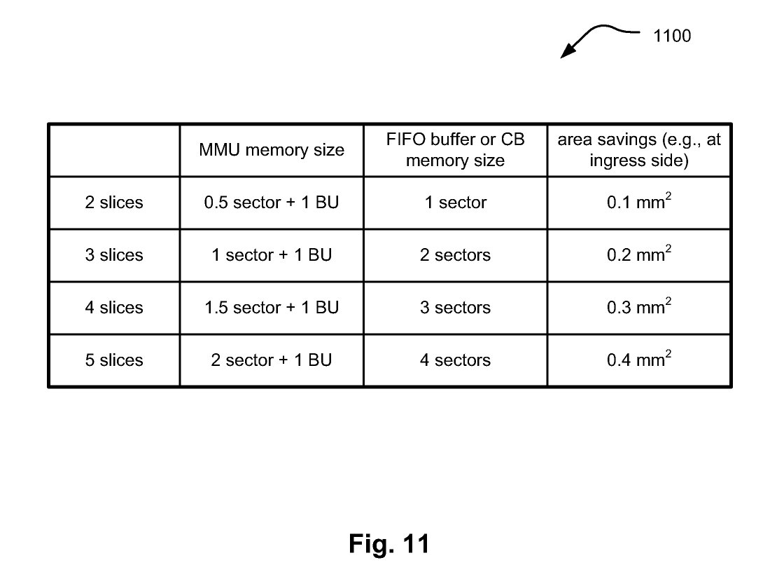

FIG. 11 illustrates an embodiment of a comparison 1100 of memory size and area savings provided by various implementations of an apparatus implemented to perform memory management. Generally speaking, the total size of the memory needed for a given number or slices, n, is as follows:

$$( \frac{( n - 1 )}{2} ) of sector size + 1 buffer unit .$$

For example, for 2 slices, n=2, and the total size of the memory needed for a given number or slices, 2, is as follows:

$$( \frac{( 2 - 1 )}{2} ) of sector size + 1 buffer unit = 0.5 sector + 1 buffer unit .$$

For 3 slices, n=3, and the total size of the memory needed for a given number or slices, 2, is as follows:

$$( \frac{( 3 - 1 )}{2} ) of sector size + 1 buffer unit = 1 sector + 1 buffer unit .$$

For 4 slices, n=4, and the total size of the memory needed for a given number or slices, 2, is as follows:

$$( \frac{( 4 - 1 )}{2} ) of sector size + 1 buffer unit = 1.5 sectors + 1 buffer unit .$$

For 5 slices, n=5, and the total size of the memory needed for a given number or slices, 2, is as follows:

$$( \frac{( 5 - 1 )}{2} ) of sector size + 1 buffer unit = 2 sectors - 1 buffer unit .$$

When comparing the memory size required using the traditional FIFO or circular buffer (CB) approaches mentioned above to the novel memory management architecture and schemes presented herein, it can be seen that employing 2 slices in accordance with the novel means presented herein required only 0.5 sector +1 buffer unit vs. 1 sector if using the traditional FIFO or circular buffer (CB) approaches. This provides an area savings of approximately 0.1 square mms when compared to the traditional FIFO or circular buffer (CB) approaches.

When employing 3 slices in accordance with the novel means presented herein, only 1 sector +1 buffer unit are employed vs. 2 sectors if using the traditional FIFO or circular buffer (CB) approaches. This provides an area savings of approximately 0.2 square mms when compared to the traditional FIFO or circular buffer (CB) approaches.

When employing 4 slices in accordance with the novel means presented herein, only 1.5 sectors +1 buffer unit are employed vs. 3 sectors if using the traditional FIFO or circular buffer (CB) approaches. This provides an area savings of approximately 0.3 square mms when compared to the traditional FIFO or circular buffer (CB) approaches.

When employing 5 slices in accordance with the novel means presented herein, only 2 sectors +1 buffer unit are employed vs. 4 sectors if using the traditional FIFO or circular buffer (CB) approaches. This provides an area savings of approximately 0.4 square mms when compared to the traditional FIFO or circular buffer (CB) approaches.

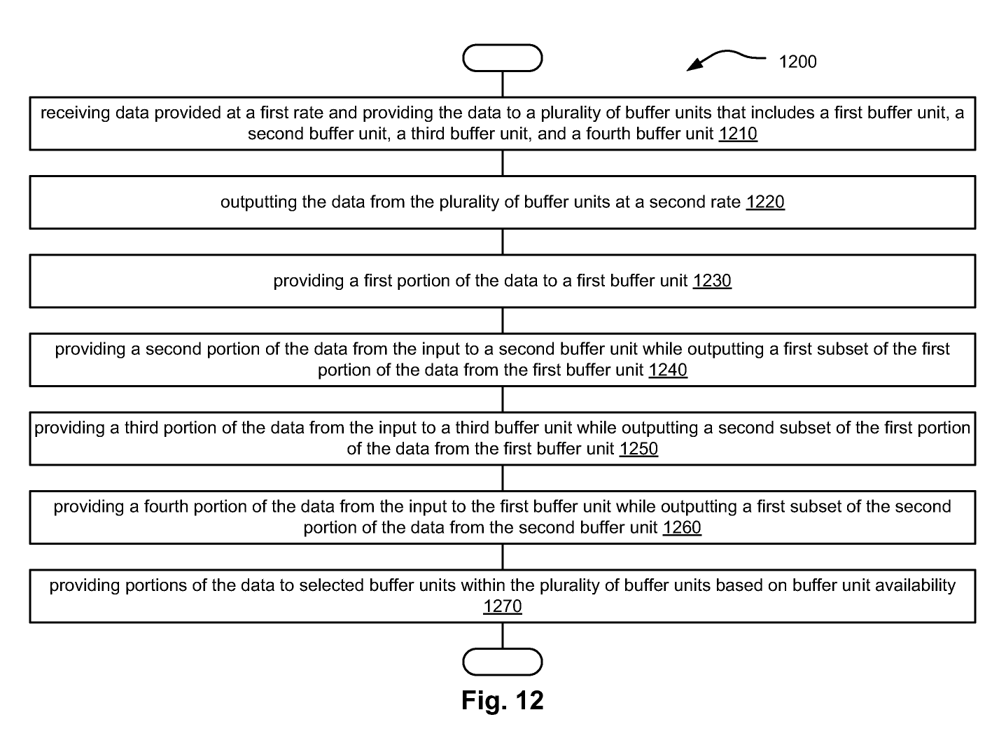

FIG. 12 illustrates an embodiment of a method 1200 for performing memory management. The method 1200 operates by receiving data provided at a first rate and providing the data to a plurality of buffer units that includes a first buffer unit, a second buffer unit, a third buffer unit, and a fourth buffer unit, as shown in a block 1210.

The method 1200 continues by outputting the data from the plurality of buffer units at a second rate, as shown in a block 1220. The method 1200 continues by providing a first portion of the data to a first buffer unit, as shown in a block 1230.

The method 1200 continues by providing a second portion of the data from the input to a second buffer unit while outputting a first subset of the first portion of the data from the first buffer unit, as shown in a block 1240. The method 1200 continues by providing a third portion of the data from the input to a third buffer unit while outputting a second subset of the first portion of the data from the first buffer unit, as shown in a block 1250.

The method 1200 continues by providing a fourth portion of the data from the input to the first buffer unit while outputting a first subset of the second portion of the data from the second buffer unit, as shown in a block 1260. The method 1200 continues by providing portions of the data to selected buffer units within the plurality of buffer units based on buffer unit availability, as shown in a block 1270.

It is noted that the various modules (e.g., encoder, decoder, apparatus to perform memory management, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus implemented to perform memory management, the apparatus comprising:
a plurality of buffer units that includes a first buffer unit, a second buffer unit, a third buffer unit, and a fourth buffer unit;
an input implemented to receive data provided at a first rate and to provide the data to the plurality of buffer units; and
an output implemented to output the data from the plurality of buffer units at a second rate; and wherein:
a first portion of the data is provided to a first buffer unit;
a second portion of the data is provided from the input to a second buffer unit while the output outputs a first subset of the first portion of the data from the first buffer unit;
a third portion of the data is provided from the input to a third buffer unit while the output outputs a second subset of the first portion of the data from the first buffer unit; and
a fourth portion of the data is provided from the input to the first buffer unit while the output outputs a first subset of the second portion of the data from the second buffer unit.

2. The apparatus of claim 1, further comprising:
an arbiter and a scheduler implemented to operate cooperatively to provide portions of the data to selected buffer units within the plurality of buffer units based on buffer unit availability.

3. The apparatus of claim 1, wherein:
the second rate is one-half of the first rate.

4. The apparatus of claim 1, wherein:
the input receives the data from an analog front end (AFE).

5. The apparatus of claim 1, wherein:
the output begins to output the first subset of the first portion of the data as the input receives the second subset of the first portion of the data.

6. The apparatus of claim 1, wherein:
each of the first portion of the data, the second portion of the data, the third portion of the data, and the fourth portion of the data has a common size;
the input receives the data via two slice data paths;
the plurality of buffer units include n buffer units such that n is an integer; and
n−1 of the buffer units within the plurality of buffer units have an aggregated storage capability corresponding to one-half of the common size.

7. The apparatus of claim 1, wherein:
each of the first portion of the data, the second portion of the data, the third portion of the data, and the fourth portion of the data has a common size;
the input receives the data via three slice data paths;
the plurality of buffer units include n buffer units such that n is an integer; and
n−1 of the buffer units within the plurality of buffer units have an aggregated storage capability corresponding to the common size.

8. The apparatus of claim 1, wherein:
each of the first portion of the data, the second portion of the data, the third portion of the data, and the fourth portion of the data has a common size;
the input receives the data via four slice data paths;
the plurality of buffer units include n buffer units such that n is an integer; and
n−1 of the buffer units within the plurality of buffer units have an aggregated storage capability corresponding to one and a half times the common size.

9. The apparatus of claim 1, wherein:
each of the first portion of the data, the second portion of the data, the third portion of the data, and the fourth portion of the data has a common size;
the input receives the data via five slice data paths;
the plurality of buffer units include n buffer units such that n is an integer; and
n−1 of the buffer units within the plurality of buffer units have an aggregated storage capability corresponding to two times the common size.

10. The apparatus of claim 1, wherein:
the data is read from a plurality of sectors of information storage media of a hard disk drive (HDD).

11. The apparatus of claim 1, wherein:
the data is read from a plurality of sectors of information storage media of a hard disk drive (HDD);
the first portion of the data and the second portion of the data are read from a first sector of the plurality of sectors; and
the third portion of the data and the fourth portion of the data are read from a second sector of the plurality of sectors.

12. The apparatus of claim 1, wherein:
the apparatus is implemented within a hard disk drive (HDD).

13. An apparatus implemented to perform memory management, the apparatus comprising:
a plurality of buffer units that includes a first buffer unit, a second buffer unit, a third buffer unit, and a fourth buffer unit;
an input implemented to receive data provided at a first rate and to provide the data to the plurality of buffer units;
an output implemented to output the data from the plurality of buffer units at a second rate; and
an arbiter and a scheduler implemented to operate cooperatively to provide portions of the data to selected buffer units within the plurality of buffer units based on buffer unit availability; and wherein:
the data is read from a plurality of sectors of information storage media of a hard disk drive (HDD);
a first portion of the data is provided to a first buffer unit;
a second portion of the data is provided from the input to a second buffer unit while the output outputs a first subset of the first portion of the data from the first buffer unit;
a third portion of the data is provided from the input to a third buffer unit while the output outputs a second subset of the first portion of the data from the first buffer unit; and
a fourth portion of the data is provided from the input to the first buffer unit while the output outputs a first subset of the second portion of the data from the second buffer unit.

14. The apparatus of claim 13, wherein:
the input receives the data from an analog front end (AFE) of the HDD.

15. The apparatus of claim 13, wherein:
the output begins to output the first subset of the first portion of the data as the input receives the second subset of the first portion of the data.

16. The apparatus of claim 13, wherein:
each of the first portion of the data, the second portion of the data, the third portion of the data, and the fourth portion of the data has a common size;
the input receives the data via three slice data paths;
the plurality of buffer units include n buffer units such that n is an integer; and
n−1 of the buffer units within the plurality of buffer units have an aggregated storage capability corresponding to the common size.

17. The apparatus of claim 13, wherein:
the first portion of the data and the second portion of the data are read from a first sector of the plurality of sectors; and
the third portion of the data and the fourth portion of the data are read from a second sector of the plurality of sectors.

18. A method for performing memory management, the method comprising:
receiving data provided at a first rate and providing the data to a plurality of buffer units that includes a first buffer unit, a second buffer unit, a third buffer unit, and a fourth buffer unit;
outputting the data from the plurality of buffer units at a second rate;
providing a first portion of the data to a first buffer unit;
providing a second portion of the data from the input to a second buffer unit while outputting a first subset of the first portion of the data from the first buffer unit;
providing a third portion of the data from the input to a third buffer unit while outputting a second subset of the first portion of the data from the first buffer unit;
providing a fourth portion of the data from the input to the first buffer unit while outputting a first subset of the second portion of the data from the second buffer unit; and
providing portions of the data to selected buffer units within the plurality of buffer units based on buffer unit availability.

19. The method of claim 18, further comprising:
receiving the data via two slice data paths; and wherein:
each of the first portion of the data, the second portion of the data, the third portion of the data, and the fourth portion of the data has a common size;
the plurality of buffer units include n buffer units such that n is an integer; and
n−1 of the buffer units within the plurality of buffer units have an aggregated storage capability corresponding to one-half of the common size.

20. The method of claim 18, wherein:
the method is performed within a hard disk drive (HDD).
